(19) United States
(12) Patent Application Publication
(10) Pub. No.: US 2026/0036671 A1
(43) Pub. Date: Feb. 5, 2026

(54) METHOD FOR A UWB DEVICE

(71) Applicant: HELLA GMBH & CO. KGAA, Lippstadt (DE)

(72) Inventors: Roman Curkin, Lippstadt (DE); Oliver Kirsch, Wuppertal (DE); Joachim Olk, Lippstadt (DE); Ludger Weghaus, Lippstadt (DE)

(21) Appl. No.: 19/285,224

(22) Filed: Jul. 30, 2025

(30) Foreign Application Priority Data
Aug. 5, 2024 (DE) 102024122288.3

(51) Int. Cl. G01S 7/03; G01S 7/28; G01S 13/931

(52) U.S. Cl. CPC G01S 7/03; G01S 7/28; G01S 13/931

(57) ABSTRACT

The invention relates to a method for a UWB device of a vehicle. The method includes: receiving, by a control unit, a plurality of channel impulse responses of a UWB device of a vehicle, wherein the plurality of channel impulse responses are each received at different points in time and each have amplitude values that are specific to successive distance values; applying, by the control unit, a filter to the plurality of channel impulse responses to obtain a plurality of filtered channel impulse responses, wherein at least one filter parameter of the filter is designed as a function of a gradient of the amplitude values of the plurality of channel impulse responses; and operating, by the control unit, the vehicle as a function of the filtered channel impulse response. Further, the invention relates to a computer program product, a computer-readable data carrier, a control unit, and a vehicle.

### CROSS-REFERENCE TO RELATED APPLICATIONS

The present application claims the benefit of German Patent Application No. 10-2024-122-288.3, filed Aug. 5, 2024, the disclosure of which is incorporated by reference.

### FIELD OF THE INVENTION

The present invention relates to a method, a computer program product, a computer-readable data carrier, a control unit, and a vehicle.

### BACKGROUND OF THE INVENTION

Vehicles are known which have sensors, for example ultra-wideband (UWB) devices, LIDAR, cameras and/or ultrasonic sensors, to detect static objects (and/or moving objects). It may be provided that a UWB device is configured to detect and/or authenticate vehicle access and/or a driver's license, for example by detecting and/or recognizing and/or locating a person (and/or an ID issuer). A UWB device can receive and/or provide a plurality of channel impulse responses. As a function of this, the distance to objects can be determined, for example.

The state of the art has disadvantages. Thus, it may be the case that the noise is increased at least in sections and/or for certain distance values. It may also be the case that the signal-to-noise ratio (SNR) is not optimal. It may also be provided that existing (pre-)processing steps, in particular filtering, are too computationally intensive. Accordingly, weight and/or costs (due to additional computing units) may be increased. It may also be the case that too much redundancy of UWB devices is provided, as these are (in each case) only customized for a specific task. Thus, the installation space may be unnecessarily large. It may also be the case that existing UWB devices cannot be optimized, for example because they can no longer be modified after installation (in terms of software and/or hardware).

It is therefore an object of the present invention to at least partially overcome at least one of the disadvantages described above. In particular, it is the object of the invention to provide an improved method for a UWB device. Furthermore, it can be an object to optimize safety, accuracy, speed when driving, reliability, robustness, costs, complexity, weight, required installation space, computing efficiency and/or the signal-to-noise ratio.

### SUMMARY OF THE INVENTION

The above object is achieved by a method, a computer program product, a computer-readable data carrier, an control unit, and a vehicle. Features and details described in connection with the invention of course also apply in connection with the computer program product according to the invention and/or in connection with the computer-readable data carrier according to the invention and/or in connection with the control unit according to the invention and/or in connection with the vehicle according to the invention, and vice versa in each case, so that reference is or can always be made to the individual aspects of the invention with respect to the disclosure. In particular, advantages described in the first, second, third, fourth and/or fifth aspect also apply to the first, second, third, fourth, and/or fifth aspect, respectively.

The above object is achieved according to a first aspect by a method for a UWB device of a vehicle (e.g. according to the fifth aspect), comprising: receiving, by a control unit, a plurality of channel impulse responses of a UWB device of a vehicle, wherein the plurality of channel impulse responses are each received at different (consecutive) points in time and each have amplitude values specific to (temporally and/or spatially) consecutive distance values; applying, by the control unit, a filter to the plurality of channel impulse responses to obtain a plurality of filtered channel impulse responses, wherein at least one filter parameter of the filter is designed as a function of a gradient of the amplitude values of the plurality of channel impulse responses; operating, by the control unit, the vehicle as a function of the filtered channel impulse responses.

The method according to the first aspect may be computer-implemented and/or may be carried out repeatedly and/or continuously. Preferably, the method can be carried out when, before and/or (preferably) while operating or using a vehicle and/or a control unit. In this case, operating can be (manual) driving, autonomous driving and/or (at least partially) automated driving. Alternatively or additionally, the method can be carried out at (regular) time intervals (e.g. speed-dependent and/or dependent on the detection of objects or vehicles). The control unit can (at least partially) implement the method, for example by carrying out (in a combined manner) of the (above-mentioned) steps and/or by controlling corresponding components (e.g. the UWB device). The method can be used to optimize a signal-to-noise ratio for a UWB device.

In the context of the invention, a vehicle may comprise a motor vehicle and/or a truck. A vehicle may be configured for operating, in particular for autonomous and/or (at least partially) automated driving.

In this case, the vehicle may have the UWB device (UWB, Ultra-Wide-Band), for example in the front region of the vehicle. This allows objects, e.g. a person, to be detected by the UWB device. It may be provided that a UWB device is configured to detect and/or authenticate vehicle access and/or a driver's license, for example by detecting and/or recognizing and/or locating a person (and/or an ID issuer) in front of the UWB device.

The control unit can be integrated into the UWB device. Alternatively or additionally, the (central and/or separate) control unit can be included in the vehicle.

The receiving, by a control unit, of a plurality of channel impulse responses of a UWB device of a vehicle, wherein the plurality of channel impulse responses are each received at different points in time and each have amplitude values which are specific for successive distance values (e.g. specific for certain distances in front of the vehicle and/or in front of the UWB device), can thereby take place by (repeated) transmission and/or reception of radar waves by the UWB device, in particular at successive points in time. The radar waves can be at least partially reflected by an object (e.g. a vehicle driving in front) and then received. A channel impulse response can be provided by an (auto-) correlation between the transmitted and received radar waves, in particular by the UWB device. The channel impulse response(s) can be transmitted to the control unit, for example via a (wired or wireless) data connection. Accordingly, the control unit can receive the plurality of channel impulse responses. A plurality of channel impulse responses can have at least 10, at least 50, at least 100, at least 500 or at least 1000, for example 10000 channel impulse responses, which are preferably (all) determined one after the other, in particular at different consecutive points in time. One (each) channel impulse response can have successive distance values (e.g. 300), each comprising a (corresponding) amplitude. The amplitude can be specific for (all) signals (e.g. of different objects) which are or were detected for a certain distance value (in particular at a certain distance, preferably [or more precisely] in a certain distance range, e.g. of 30 cm).

Applying, by the control unit, a filter to the plurality of channel impulse responses to obtain a plurality of filtered channel impulse responses, wherein at least one filter parameter of the filter is designed as a function of a gradient of the amplitude values of the plurality of channel impulse responses, may comprise applying the filter (or a plurality of filters) consecutively and/or separately to amplitude values (of corresponding distance values) of different channel impulse responses, respectively. In other words, it may be provided for all amplitude values of the different channel impulse responses (of the plurality of channel impulse responses) for a (each) specific distance value to be extracted (e.g. into a vector), and to apply a filter for these (each separately), for example a specific high-pass filter (see below). In other words, the filter can be applied to the amplitudes (of a [same] distance value) along a time direction that is specific to different points in time (of the channel impulse responses). The idea of the invention can be seen in the fact that a specific filter, in particular with special filter parameters, is used for different distance values, particularly preferably for those which have a high gradient and/or lie in a section of the channel impulse response with a high gradient. Distance values and/or distance ranges of a channel impulse response with a (comparatively) high gradient can exhibit a (comparatively) high level of noise, which can be advantageously reduced by filtering, in particular targeted filtering in this range. This can improve the signal-to-noise ratio. The at least one filter parameter can be (specially) adapted, in particular as a function of the (respective) gradient, for one (each) distance value and/or for one (each) distance value of a distance range. It may be provided that the gradient is (separately) determined for each distance value (and each channel impulse response) (see below). It may also be provided that (e.g. adjacent) distance values, in particular those with a similar gradient, use identical filter parameters. This can reduce the (necessary) computing power and/or improve efficiency and/or speed. The plurality of filtered channel impulse responses can be obtained as a result. The plurality of filtered channel impulse responses can correspond to the plurality of channel impulse responses that were filtered (in each case), in particular for each distance value (along the time direction).

Operating the vehicle by the control unit as a function of the filtered channel impulse response can use the optimized result in terms of the signal-to-noise ratio. This can improve subsequent calculations and/or determining, e.g. of the distance to an object.

Within the framework of the invention, it may be advantageous that applying the filter to the amplitude values (of a particular distance value) comprises for different, in particular consecutive, points in time, wherein in particular the filter is applied for different (consecutive) distance values one after the other and/or separately.

A separate and/or specific application of the filter can increase the signal-to-noise ratio, in particular by achieving an amplified and/or specific filtering of amplitudes with amplified noise.

Within the framework of the invention, it is conceivable that the filter has a high-pass filter, wherein the at least one filter parameter is specific to the high-pass filter.

The filter can have at least one, in particular multiple, filter parameters which characterize the filter, in particular its, preferably frequency-dependent, attenuation. The filter can be configured to reduce and/or minimize (amplified) noise, in particular at low frequencies (e.g. stationary objects have no frequency). For example, a high-pass filter can be used. It can be configured to reduce and/or minimize noise, in particular low-frequency noise. The high-pass filter can, for example, have a finite impulse response filter. The at least one filter parameter can, for example, have and/or be specific for: a cut-off frequency; a stopband or blocking band (e.g. 24.1 GHz); a passband (e.g. 24.2 GHz); one (or more) passband ripples (or passband rounding, e.g. 0.5); stopband attenuation (stopband or blocking band attenuation), e.g. 65 dB; and/or a specific filter design (e.g. “equiripple”).

A filter can, for example, comprise a convolution. For example (e.g. for a finite impulse response [FIR]), the output y(k) of the filter can have a convolution of the input signal x(k) (in particular the amplitude values for different points in time) with an impulse response h(k) (or step response):

$$y ( k ) = {\sum }_{l = - ∞}^{∞} h ( l ) x ( k - l )$$

The filter can have a transfer function which has a Z-transform of the impulse response. For example, for a finite impulse response filter, the Z-transform Y(k) of the output y(k) can be the product of the transfer function H(z) and the Z-transform X(z) of the input signal x(k):

$$Y ( z ) = H ( z ) X ( z ) = ( h ( 1 ) + h ( 2 ) {z}^{- 1} + … + h ( n + 1 ) {z}^{- 1} ) * X ( z )$$

In this case, h(1), h(2), . . . , h(n+1) can have and/or represent the filter parameters (or filter coefficients). The following can apply to an infinite impulse response filter:

$$Y ( z ) = H ( z ) X ( z ) = \frac{b ( 1 ) + b ( 2 ) {z}^{- 1} + … + b ( n + 1 ) {z}^{- n}}{a ( 1 ) + a ( 2 ) {z}^{- 1} + … + a ( m + 1 ) {z}^{- m}} * X ( z )$$

Here, a(1), a(2), . . . , a(m+1) and/or b(1), b(2), . . . , b(n+1) can have and/or represent the filter parameters (or filter coefficients). In this case, it can be applied, in particular provided that the (rational) transfer function can be represented, in particular as a difference equation, as follows:

$$a ( 1 ) y ( n ) = b ( 1 ) x ( n ) + b ( 2 ) x ( n - 1 ) + … + b ( nb + 1 ) x ( n - nb ) - a ( 2 ) y ( n - 1 ) - … - a ( na + 1 ) y ( n - na )$$

The following may apply, in particular if na=1 and nb=1:

$$a ( 1 ) y ( n ) = b ( 1 ) x ( n ) + b ( 2 ) x ( n - 1 ) - a ( 2 ) y ( n - 1 )$$

For example, the filter parameters can be selected as follows:

$$b ( 1 ) = 1 , b ( 2 ) = - 1 \\ a ( 1 ) = 1 \\ a ( 2 ) = 0 , 999$$

In particular, the filter parameter, for example a(2), can be changed and/or adjusted. The following values can be used, for example:

$$a ( 2 ) = 0.98 , a ( 2 ) = 0.995 , a ( 2 ) = 0.9975 , a 〈 2 ) = 0.999 , a ( 2 ) = 0.9995 , and / or \\ a ( 2 ) = 1.$$

The aforementioned values are here comparatively high. It may be provided that the smaller the filter parameter, e.g. a(2), the stronger the filter effect and/or attenuation (in particular, the cut-off frequency of the filter can be lower [due to that]) (and in particular vice versa). It may be provided that the smaller the filter parameter, in particular a(2), the more strongly signal components with low frequencies are filtered and/or attenuated (and vice versa). In the case of a high gradient, stronger filtering and/or attenuation may be required (due to higher level of noise). Advantageously, this allows large amplitude changes to be filtered and/or damped more effectively. Overall, this can improve the signal-to-noise ratio. With a low gradient, weaker filtering and/or attenuation can be provided (due to lower level of noise). As a result, changing amplitudes can be advantageously detected and/or are not undesirably filtered out and/or attenuated.

The filter parameter can be (re)adjusted at preferably regular intervals, e.g. every 24 ms.

It may be provided that at least one filter parameter is adjusted as a function of the gradient. This allows the noise to be reduced in a targeted manner. It may be provided that the dependency between (optimized) filter parameters and gradient is defined and/or stored, for example in the control unit. The dependency can be determined by simulations and/or empirically, for example by calibration, e.g. during commissioning. For example, different predefined constellations (e.g. distance to object, speed, noise components) can be used to obtain an optimized result by changing the filter parameters.

It may be provided within the framework of the invention that, when applying the at least one filter parameter as a function of a gradient which is specific for a corresponding distance value, in particular for a corresponding distance range, said filter parameter is taken from a predefined look-up table, and in particular is used for applying the filter for all distance values of a corresponding distance range.

It may be provided that a gradient is determined for each distance value (in each case). It may be provided that a distance range comprising the respective distance value and at least one or more adjacent distance values is used. Distance values within a distance range can preferably have (substantially) the same gradient. For example, it may be provided that a distance range is predefined and/or (initially) has three (or ten) distance values. The gradient for each distance value and/or the distance values in the distance range can be determined, for example by linear fitting. It may then be provided to compare the gradient with adjacent, in particular preceding and/or following distance ranges. If the gradient is (substantially) identical, a (common) gradient can be used, e.g. by averaging. This allows contiguous distance ranges (as large as possible) to be determined, which substantially have the same gradient. The (different) distance values of a distance range can each have the same (determined) gradient. A distance range can preferably be used as a function of (or for) a first channel impulse response. For further (different) channel impulse responses, which may in particular have a substantially similar course, the (already determined) distance ranges can therefore be used, for example as a predefined distance range and/or as a starting point (e.g. “best guess”). It may also be provided that one (or each) channel impulse response is subjected to smoothing, in particular before the gradient is determined, which smoothing is performed by the control unit. This allows distance ranges to be determined quicker and/or more efficiently. Distance values and/or distance ranges with (substantially) identical gradients, in particular with a gradient in a specific gradient interval, can be assigned identical filter parameters. The filter parameters can be configured to provide an optimized signal-to-noise ratio through (improved) filtering. The at least one filter parameter can be provided (predefined) for each gradient, in particular for certain gradient intervals (e.g. from 1 to 1.1 et cetera), preferably in a look-up table. This allows the control unit to assign an (optimized) filter parameter to each distance value and/or each distance range, which filter parameter is preferably used during filtering. The look-up table can be determined, for example, as part of simulations and/or a calibration (e.g. during commissioning).

It is further conceivable that the applying comprises determining (by the control unit) the gradient of the amplitude values for each distance value, wherein the gradient for each amplitude value is performed: as a function of the amplitude value and at least one adjacent (e.g. preceding and/or following) amplitude value (e.g. by a linear fit); and/or as a function of the amplitude value for a plurality of adjacent amplitude values over a distance range, e.g. by smoothing and/or (linear) fitting.

The gradient can preferably be determined individually and/or separately for each channel impulse response. Preferably, a gradient can be assigned to each distance value. This can be done preferably over distance ranges. Accordingly, each amplitude value of a channel impulse response can have a gradient or a gradient value. Preferably, it may be the case that the gradient for distance values at different points in time and/or for different channel impulse responses of the plurality of channel impulse responses may be substantially identical and/or similar. As a result, it may be provided that determining the gradient, in particular by means of fitting, for subsequent channel impulse responses is made easier. The determining can be carried out for at least two distance values or a distance range (e.g. 10 adjacent distance values). Determining may include checking for a (substantially) continuous gradient, wherein in particular differences in gradient of more than 5%, more than 10% or more than 20% may separate adjacent distance ranges. Accordingly, it may be provided for different distance values to have a different number of distance values. Preferably, a distance range has a substantially constant gradient and/or a substantially linear progression (of the amplitude values). Determining may comprise (initial) smoothing, preferably to smooth out fluctuations in the amplitude (which could lead to a distortion of the gradient). Additionally or alternatively, an algorithm can be used which is configured to recognize shape, structure and/or linear sections. This allows the distance ranges to be determined efficiently. A small(er) number of distance ranges can improve efficiency and/or speed.

It is also conceivable that the determining comprises a fitting of a linear function. The linear function can be fitted (section by section) between adjacent distance values. It may also be provided that said linear function is fitted between the first and last distance value of a distance range (to all intermediate distance values or amplitudes). A fitting can preferably be carried out to the corresponding amplitude (or amplitude values). By determining the gradient of the linear (fit) function, the gradient for the respective distance values can be determined (these can be identical). Accordingly, the at least one filter parameter for these (corresponding) distance values can be identical or be determined. A linear fit can be carried out particularly (computationally) efficiently and/or quickly.

Within the framework of the invention, it is optionally possible that the determining comprises a fitting of a spline function.

The spline function can be fitted (section by section) between adjacent distance values. It may also be provided that said linear function is fitted between the first and last distance value of a distance range (to all intermediate distance values or amplitudes). A fitting can preferably be carried out to the corresponding amplitude (or amplitude values). By determining the gradient of the spline function (e.g. by forming a [mathematical] derivative), the gradient for the respective distance values (in the respective distance value) can be determined (these can be identical). Accordingly, the at least one filter parameter for these (corresponding) distance values can be identical or be determined. A spline function can provide a comparatively realistic simulation of the course. This can increase the smoothing effect and/or (simultaneously) increase the accuracy.

Furthermore, it may be provided within the framework of the invention that, when the filter is applied, the at least one filter parameter, in particular of the high-pass filter, is configured to: provide a high signal attenuation the higher the gradient, in particular in the corresponding distance range, whereby in particular a cut-off frequency of the filter is shifted to lower frequencies; provide a low signal attenuation the lower the gradient, in particular in the corresponding distance range, is, whereby in particular a cut-off frequency of the filter is shifted to higher frequencies.

Advantageously, a higher signal attenuation can be provided at or for a higher gradient, in particular with increased noise. Advantageously, a lower signal attenuation can be provided with or for a lower gradient, in particular with reduced noise. Thus, the overall signal-to-noise ratio can advantageously be improved. In other words, it may be provided that ranges with higher level of noise are attenuated more than ranges with (comparatively) lower level of noise.

Furthermore, it may be provided within the framework of the invention that, when the filter is applied, the at least one filter parameter, in particular of the high-pass filter: is the higher, the higher the gradient, in particular in the corresponding distance range; or is the lower, the lower the gradient, in particular in the corresponding distance range.

In particular, it may be provided that the at least one filter parameter has an attenuation which is preferably higher with a higher gradient (e.g. 100 dB) than with a smaller one (e.g. 0 dB). This can reduce the noise and/or amplitude jumps (or their influence).

Furthermore, it may be provided within the framework of the invention that, when the filter is applied, the at least one filter parameter, in particular of the high-pass filter: is the lower, the higher the gradient, in particular in the corresponding distance range; or is the higher, the lower the gradient, in particular in the corresponding distance range.

For example, the blocking band can be shifted to higher frequencies if the gradient is higher.

In relation to the present invention, it is conceivable that the operating, by the control unit, of the vehicle as a function of the filtered channel impulse response comprises at least one of the following functions: determining a distance, for example to a vehicle driving in front; autonomous and/or at least partially automated operating, in particular driving, the vehicle; activating an alarm function; detecting a presence, in particular in a vehicle interior of the vehicle, for humans and/or animals; and/or actuating a moving part of the vehicle, in particular a detection of a user action, for example a kick movement.

A movable part can comprise a door and/or a tailgate, for example. This allows a convenient opening function to be provided.

The above object is achieved according to a second aspect by a computer program product according to the invention, comprising instructions which, when the computer program product is executed by a computer, cause the computer to implement the method according to the first aspect.

This results in the same advantages with respect to a computer program product according to the invention as have already been described with respect to a method according to the invention according to the first aspect.

The above object is achieved according to a third aspect by a computer-readable data carrier according to the invention, in which instructions are stored which, when executed by a computer, cause the computer to carry out the method according to the first aspect.

This results in the same advantages with respect to a computer-readable data carrier according to the invention as have already been described with respect to a method according to the invention according to the first aspect and/or a computer program product according to the invention according to the second aspect.

The above object is achieved according to a fourth aspect by a control unit having a computing unit and a memory unit in which instructions are stored which, when at least partially executed by the computing unit, carry out a method according to the first aspect.

This results in the same advantages with respect to an control unit according to the invention as have already been described with respect to a method according to the invention according to the first aspect and/or a computer program product according to the invention according to the second aspect and/or a computer-readable data carrier according to the invention according to the third aspect.

The above object is achieved according to a fifth aspect by a vehicle according to the invention, comprising a control unit according to the fourth aspect.

This results in the same advantages with respect to a vehicle according to the invention as have already been described with respect to a method according to the invention according to the first aspect and/or a computer program product according to the invention according to the second aspect and/or a computer-readable data carrier according to the invention according to the third aspect and/or an control unit according to the invention according to the fourth aspect.

### BRIEF DESCRIPTION OF THE DRAWINGS

Further advantages, features and details of the invention are apparent from the following description, in which several embodiment examples of the invention are described in detail with reference to the drawings. Here, the features mentioned in the claims and in the description can each be essential to the invention individually or in any combination. The figures each show schematically by way of example:

FIG. 1 is a method;

FIG. 2 is a vehicle;

FIG. 3 is a channel impulse response; and

FIG. 4 is a channel impulse response.

### DETAILED DESCRIPTION OF THE CURRENT EMBODIMENT

In the figures, the same technical features, including those of different embodiment examples, are represented by identical reference signs.

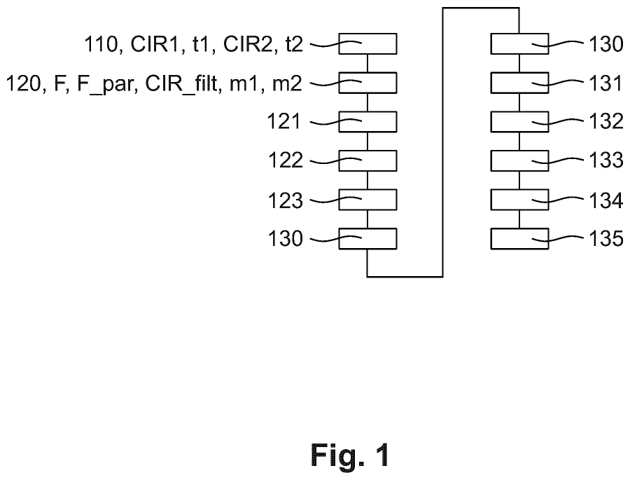

FIG. 1 shows a method for a UWB device 10 of a vehicle 200, comprising: receiving 110, by a control unit ECU, a plurality of channel impulse responses CIR1, CIR2 of a UWB device 10 of a vehicle 200, wherein the plurality of channel impulse responses CIR1, CIR2 are each received at different points in time t1, t2 and each have amplitude values A that are specific to successive distance values d; applying 120, by the control unit ECU, a filter F to the plurality of channel impulse responses CIR1, CIR2 to obtain a plurality of filtered channel impulse responses CIR_filt, wherein at least one filter parameter F_par of the filter F is designed as a function of a gradient m1, m2 of the amplitude values A of the plurality of channel impulse responses CIR1, CIR2; operating 130, by the control unit ECU, the vehicle 200 as a function of the filtered channel impulse response CIR_filt.

Within the framework of the invention, it may be advantageous that the applying 120 of the filter F to the amplitude values A comprises for different, in particular successive, points in time t1, t2, wherein in particular the filter F is applied successively and/or separately for different distance values d.

Within the framework of the invention, it is conceivable that the filter F has a high-pass filter, wherein the at least one filter parameter F_par is specific to the high-pass filter.

It may be provided within the framework of the invention that, when applying 120, the at least one filter parameter F_par is taken from a predefined look-up table as a function of a gradient m1, m2 which is specific for a corresponding distance value d1, d2, in particular for a corresponding distance range delta_d1, delta_d2, and in particular is used for applying the filter F for all distance values d1, d2 of a corresponding distance range delta_d1, delta_d2.

It is further conceivable that the applying 120 comprises determining 121 the gradient m1, m2 of the amplitude values A for each distance value d, wherein the gradient m1, m2 is performed for each amplitude value A: as a function of the amplitude value A and at least one adjacent amplitude value A; and/or as a function of the amplitude value for a plurality of amplitude values A over a distance range delta_d1, delta_d2.

It is also conceivable that the determining 121 comprises a fitting 122 of a linear function.

Within the framework of the invention, it is optionally possible that the determining 121 comprises a fitting 122 of a spline function.

Furthermore, it may be provided within the framework of the invention that, when the filter F is applied 120, the at least one filter parameter F_par, in particular of the high-pass filter: is the lower, the higher the gradient m1, m2, in particular in the corresponding distance delta_d1, delta_d2; or is the higher, the lower the gradient m1, m2 in particular in the corresponding distance delta_d1, delta_d2.

In relation to the present invention, it is conceivable that the operating 130, by the control unit, of the vehicle as a function of the filtered channel impulse response comprises at least one of the following functions: determining 131 a distance, for example to a vehicle 300 driving in front; autonomous and/or at least partially automated operating 132, in particular driving, the vehicle 200; activating 133 an alarm function; detecting 134 a presence, in particular in a vehicle interior of the vehicle 200, for humans and/or animals; and/or actuating 135 a moving part of the vehicle 200, in particular a detection of a user action, for example a kick movement.

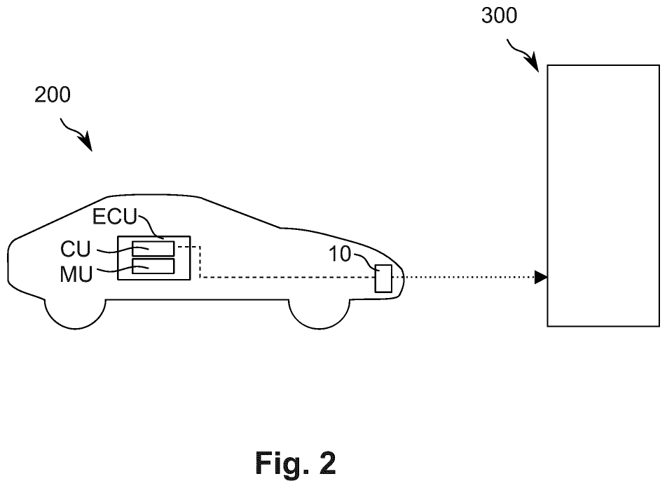

FIG. 2 shows a vehicle 200 comprising a control unit ECU having a computing unit CU and a memory unit MU. The vehicle 200 comprises a UWB device 10, which can be arranged in the front area of the vehicle 200, for example. As a result, for example, a channel impulse response CIR1, CIR2 or a plurality of channel impulse responses CIR1, CIR2 can be generated, for example when approaching an object 300, for example a vehicle 300 driving in front. A corresponding channel impulse response CIR1, CIR2 can be determined (substantially instantaneously) at different points in time t1, t2, for example during the approach.

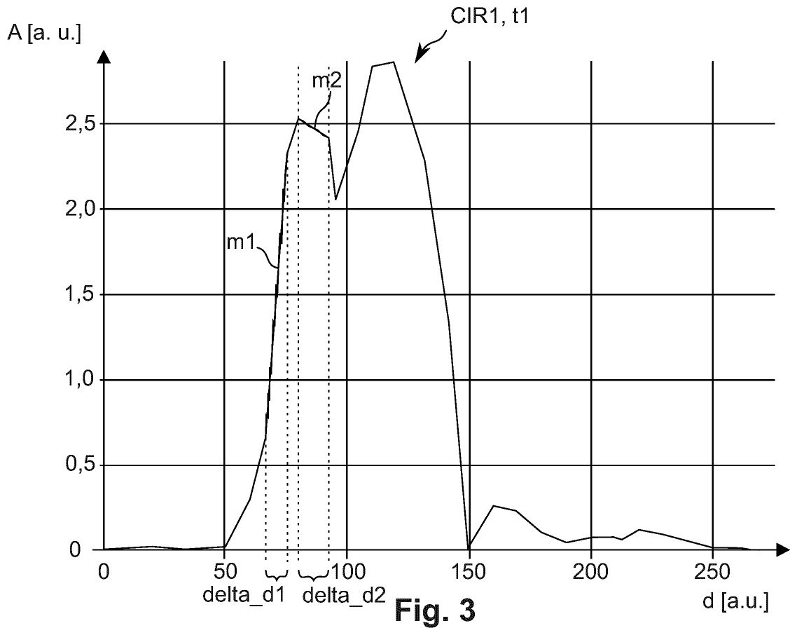

FIG. 3 shows a (first) channel impulse response CIR1, which is measured in particular at a point in time t1. Here (approximately) 250 (consecutive) distance values d (to the right) are plotted. These each have an amplitude A (plotted upwards). The amplitude A changes and, in particular, different distance ranges delta_d1, delta_d2 with different (substantially constant) gradients m1, m2 can be seen. Accordingly, it may be provided that the distance values d in the first distance range delta_d1 have (substantially) the same gradient m1, and/or that they are assigned an identical gradient m1 by the determining 121 (e.g. by smoothing prior to determining 121). Here, it may be provided that the distance values d in the second distance range delta_d2 have (substantially) the same gradient m2, and/or that they are assigned an identical gradient m2 by the determining 121 (e.g. by smoothing prior to determining 121). It may preferably be provided that distance ranges delta_d1 with a higher gradient m1 exhibit increased noise (recognizable by the stronger fluctuations of the amplitude), in particular compared to distance ranges delta_d2 with a lower gradient m2.

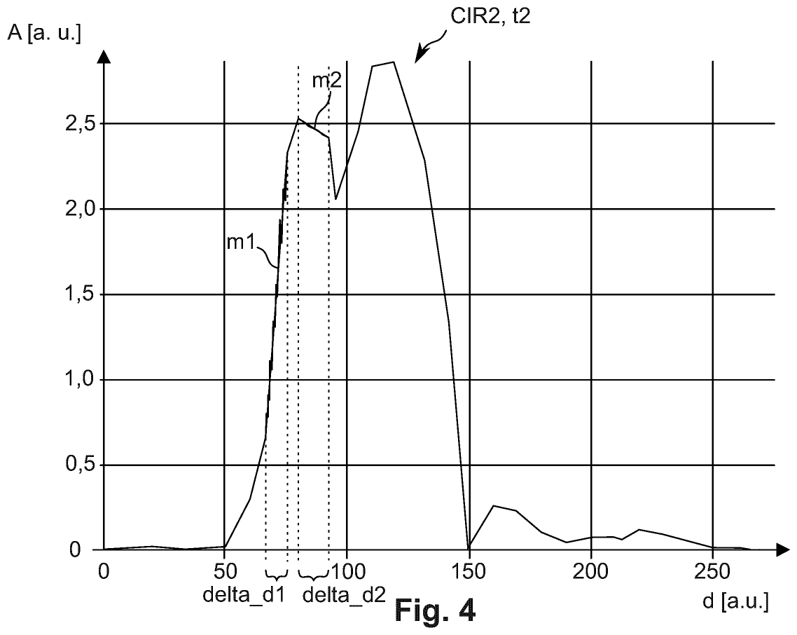

FIG. 4 shows a (second) channel impulse response CIR2, which is measured in particular at a point in time t2. Here (approximately) 250 (consecutive) distance values d (to the right) are plotted. These each have a (in comparison to FIG. 3 [slightly] changed) amplitude A (plotted upwards). The amplitude A changes and, in particular, different distance ranges delta_d1, delta_d2 with different (substantially constant) gradients m1, m2 can be seen. Accordingly, it may be provided that the distance values d in the first distance range delta_d1 have (substantially) the same gradient m1, and/or that they are assigned an identical gradient m1 by the determining 121 (e.g. by smoothing prior to determining 121). Here, it may be provided that the distance values d in the second distance range delta_d2 have (substantially) the same gradient m2, and/or that they are assigned an identical gradient m2 by the determining 121 (e.g. by smoothing prior to determining 121). It may preferably be provided that distance ranges delta_d1 with a higher gradient m1 exhibit increased noise (recognizable by the stronger fluctuations of the amplitude), in particular compared to distance ranges delta_d2 with a lower gradient m2. This can also be seen in comparison with FIG. 3. An applying 120 of the filter F in the present example can be performed for the amplitudes A of identical distance values d, which are correspondingly specific for different points in time t1, t2. In doing so, it can be determined, as a function of the gradient m1, m2, which (optimized) filter parameters F_par are used for filtering in order to optimize the signal-to-noise ratio.

### LIST OF REFERENCE SYMBOLS

UWB device
110 receiving a channel impulse response
120 applying a filter
121 determining
122 fitting a linear function
123 fitting a spline function
130 operating the vehicle
131 determining a distance
132 autonomous and/or automated operating
133 actuating an alarm function
134 recognizing a presence
135 actuating a moving part
200 vehicle
300 vehicle driving in front
ECU control unit
CU computing unit
MU memory unit
CIR1, CIR2 plurality of channel impulse responses, first channel impulse response, second channel impulse response
CIR_filt plurality of filtered channel impulse responses
A amplitude values
d distance values
delta_d1 distance range
delta_d2 distance range
F filter
F_par filter parameter
m1, m2 gradient
t1, t2 points in time of the channel impulse responses

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for an ultra-wideband (UWB) device of a vehicle, comprising:
receiving, by a control unit, a plurality of channel impulse responses of a UWB device of a vehicle, wherein the plurality of channel impulse responses are each received at different points in time and each have amplitude values that are specific to successive distance values;
applying, by the control unit, a filter to the plurality of channel impulse responses to obtain a plurality of filtered channel impulse responses, wherein at least one filter parameter of the filter is configured as a function of a gradient of the amplitude values of the plurality of channel impulse responses; and
operating, by the control unit, the vehicle as a function of the plurality of filtered channel impulse responses.

2. The method according to claim 1, wherein applying the filter to the plurality of channel impulse responses is performed successively or separately for different distance values.

3. The method according to claim 1, wherein the filter is a high-pass filter, and wherein the at least one filter parameter is specific to the high-pass filter.

4. The method according to claim 1, wherein the least one filter parameter is taken from a predefined look-up table as a function of a gradient which is specific to a corresponding distance value.

5. The method according to claim 1, wherein applying the filter to the plurality of channel impulse responses comprises determining the gradient of the amplitude values for each distance value, wherein the gradient is performed for each amplitude value as a function of the amplitude value and at least one adjacent amplitude value or as a function of the amplitude value for a plurality of amplitude values over a distance range.

6. The method according to claim 5, wherein determining the gradient comprises a fitting of a linear function.

7. The method according to claim 5, wherein determining the gradient comprises a fitting of a spline function.

8. The method according to claim 1, wherein when applying the filter, the at least one filter parameter of the filter is configured:
to provide a high signal attenuation of the correspondence distance range, whereby a cut-off frequency of the filter is shifted to lower frequencies; or
to provide a low signal attenuation of the correspondence distance range, whereby a cut-off frequency of the filter is shifted to higher frequencies.

9. The method according to claim 1, wherein when applying the filter, the at least one filter parameter of the filter:
is the lower, the higher the gradient in the corresponding distance range; or
is the higher, the lower the gradient in the corresponding distance range.

10. The method according to claim 1, wherein operating the vehicle as a function of the plurality of filtered channel impulse responses comprises at least one of the following functions:
determining a distance to a vehicle;
autonomous operation of the vehicle;
activating an alarm function;
detecting humans or animals in a vehicle interior; or
actuating a moving part of the vehicle.

11. A computer program product comprising instructions which, when the computer program product is executed by a computer, causes the computer to implement the method according to claim 1.

12. A computer-readable data carrier in which instructions are stored which, when executed by a computer, cause the computer to implement the method according to claim 1.

13. A control unit having a computing unit and a memory unit, in which instructions are stored which, when at least partially executed by the computing unit, carry out the method according to claim 1.

14. A vehicle comprising the control unit of claim 13.
